(19) United States
(12) Patent Application Publication
(10) Pub. No.: US 2013/0031317 A1
(43) Pub. Date: Jan. 31, 2013

(54) METHOD AND APPARATUS FOR REDIRECTING DATA WRITES

(71) Applicants: In Sik Ryu, Suwon-si (KR); Se Wook Na, Suwon-si (KR)

(72) Inventors: In Sik Ryu, Suwon-si (KR); Se Wook Na, Suwon-si (KR)

(73) Assignee: Seagate Technology LLC, Cupertino, CA (US)

(21) Appl. No.: 13/459,008

(22) Filed: Apr. 27, 2012

(30) Foreign Application Priority Data
Apr. 27, 2011 (KR) 10-2011-0039709

(51) Int. Cl. G06F 12/00

(52) U.S. Cl. 711/154; 711/E12.001

(57) ABSTRACT

Apparatuses and methods for redirecting data writes are disclosed. In one embodiment a controller may be configured to receive a command including write data and address data identifying a target zone of a data storage medium; determine whether the target zone contains sufficient available data sectors to store the write data; and record the write data to a common area of a different zone when the target zone does not contain sufficient available data sectors, the common area available to store data when a target zone lacks sufficient available data sectors. In another embodiment, a method may comprise receiving a write command identifying a target zone of a data storage medium; determining whether the target zone contains sufficient available data sectors to store the write data; and recording the write data to a common area of a different zone when the target zone does not contain sufficient available data sectors.

### CROSS-REFERENCE TO RELATED APPLICATIONS

This application claims priority under 35 U.S.C. §119(a) of Korean Patent Application No. 2011-0039709, filed on Apr. 27, 2011, the entire disclosure of which is hereby incorporated by reference.

### BACKGROUND OF THE INVENTION

1. Field of the Invention

The present invention relates to a method for writing data and a device using the same, and more particularly, to a method for writing data on the basis of a virtual band onto a storage medium and a storage device using the same.

2. Description of the Related Art

A storage device that can be connected to a host device may write data onto a storage medium or read data from the storage medium according to a command transmitted from the host device.

Data write technologies have been studied in various ways to enhance a recording density according to the high-capacity and high-density trend of the storage medium.

### SUMMARY OF THE INVENTION

A task of the present invention is to provide a method for writing data onto a storage medium on the basis of a virtual band and a storage device capable of performing the method.

Another task of the present invention is to provide a method for writing data using a common virtual band when each zone lacks a writable area and a storage device capable of performing the method.

In order to accomplish the foregoing tasks, a data write method according to an embodiment of the present invention may preferably include writing data onto at least one common virtual band on a storage medium when at least one of a plurality of zones on the storage medium lacks a writable area; and writing the data onto a zone corresponding to a logical address contained in a write command when each of the plurality of zones does not lack a writable area.

The common virtual band may preferably include at least one virtual band contained in at least one of the plurality of zones or at least one virtual band contained in at least two of the plurality of zones, respectively.

The data write method may further include determining whether or not a zone corresponding to a logical address contained in the write command lacks a writable area when receiving the write command. The data write method may further include updating management information on the storage medium to allow the generated free virtual band to be contained in the common virtual band when at least one free virtual band is generated from at least one zone on the storage medium.

The data write method may further include updating the management information of the storage medium to allow the generated free virtual band to be contained in the common virtual band when at least one free virtual band is generated from at least one zone on the storage medium and the zone from which the free virtual band is generated is a zone that uses the common virtual band; and updating the management information of the storage medium to allow the generated free virtual band to be contained in the zone when the zone from which the at least one free virtual band is generated is a zone that does not use the common virtual band. The storage medium may be preferably configured such that data is sequentially written on the storage medium while being overlapped with a partial area of the previous track.

In order to accomplish the foregoing tasks, a storage device according to an embodiment of the present invention may include a storage medium having a plurality of zones configured to use at least one virtual band contained in at least one of the plurality of zones as at least one common virtual band; and a processor configured to write data onto the at least one common virtual band when at least one of the plurality of zones lacks a writable area. The processor may write data onto a zone corresponding to a logical address contained in a write command when each of the plurality of zones does not lack a writable area.

The processor may check whether or not a zone corresponding to a logical address contained in the write command lacks a writable area when receiving the write command.

The processor may move a magnetic head to the at least one common virtual band on the storage medium to perform the data write operation when the at least one zone lacks a writable area, and move a magnetic head to the zone on the storage medium to perform the data write operation when the zone does not lack a writable area.

The processor may include a first processor configured to extract a logical address from the received write command; a second processor configured to convert the extracted logical address into a virtual address based on the plurality of zones or the at least one common virtual band; and a third processor configured to convert the converted virtual address into a physical address of the storage medium, and access the storage medium according to the converted physical address.

The second processor may preferably convert the logical address into the virtual address based on the management information of the at least one common virtual band when it is determined that the zone lacks a writable area based on the management information of the storage medium, and convert the logical address into the virtual address based on the management information of the zone when it is determined that the zone does not lack a writable area.

The processor may update management information on the storage medium to allow the generated free virtual band to be contained in the common virtual band when at least one free virtual band is generated from at least one zone of the storage medium.

Furthermore, the processor may update the management information of the storage medium to allow the generated free virtual band to be contained in the common virtual band when at least one free virtual band is generated from at least one zone on the storage medium and the zone from which the free virtual band is generated is a zone that uses the common virtual band, and update the management information of the storage medium to allow the generated free virtual band to be contained in the zone when the zone from which the at least one free virtual band is generated is a zone that does not use the common virtual band.

In order to accomplish the foregoing tasks, in a storage medium that can be read by a computer stored with a program capable of performing a data write method according to an embodiment of the present invention, the data write method may be carried out as described in the foregoing data write method.

According to an embodiment of the present invention, when at least one of a plurality of zones lacks a writable area in a storage medium having the plurality of zones, data may be written using at least one common virtual band to reduce the number of merge generations due to the lack of the writable area in the zone unit, thereby enhancing the write performance of the storage device.

For example, when a writable area is insufficient in a specific zone as data is intensively written on the specific zone of the storage medium, the data may be written onto at least one common virtual band specified on the storage medium, and accordingly, the number of merge generations due to the lack of the writable area in the specific zone can be reduced though there exists a physically writable area on the storage medium. As a result, when data is intensively written onto a specific zone of the storage medium, it may be possible to prevent the write performance of the storage medium from being deteriorated, and increasing the response speed to a write command received from the host.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1A is a functional block diagram illustrating a host device—storage device based system according to a preferred embodiment of the present invention;

FIG. 1B is a functional block diagram illustrating a host device—storage device based system according to another preferred embodiment of the present invention;

FIGS. 2A through 2F are exemplary views illustrating the setting of a common virtual band to be used according to a preferred embodiment of the present invention;

FIG. 3 is an exemplary view illustrating relations between a zone, a logical band and a virtual band on a storage medium;

FIG. 4 is a comparative exemplary view illustrating a zone in which write commands are intensively received and a zone in which write commands are not intensively received;

FIGS. 5A and 5B are views for explaining a limiting condition in case where data is written based on a shingled write operation;

FIG. 6A is a schematic structural view of a mapping table, and FIG. 6B is a schematic structural view of SAT;

FIG. 7 is a plan view illustrating a head disk assembly in case when the storage device of FIG. 1A is a disk drive;

FIG. 8 is an example illustrating a sector architecture for one track of the disk illustrated in FIG. 7;

FIG. 9 is an example illustrating the structure of a servo area illustrated in

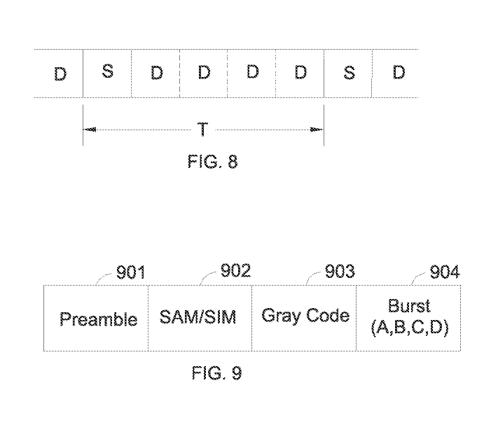

FIG. 8;

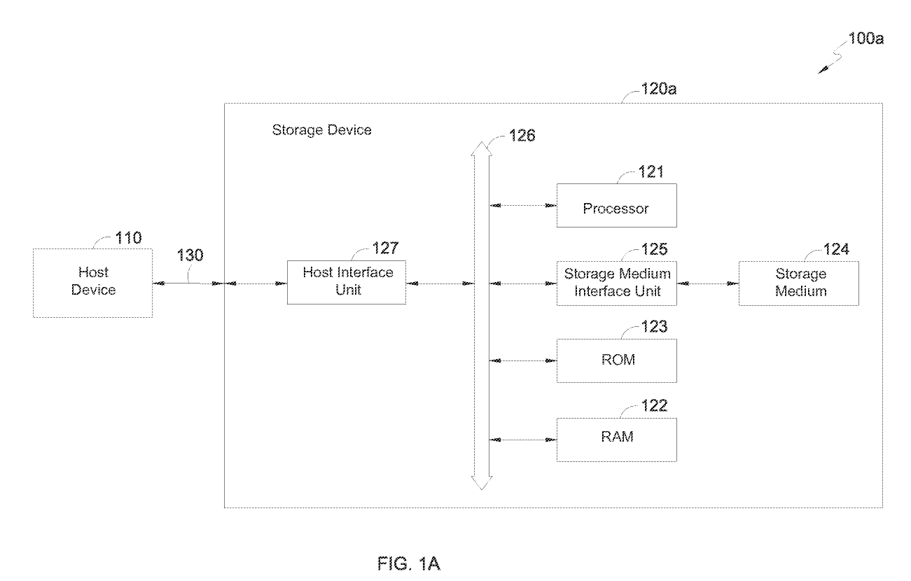

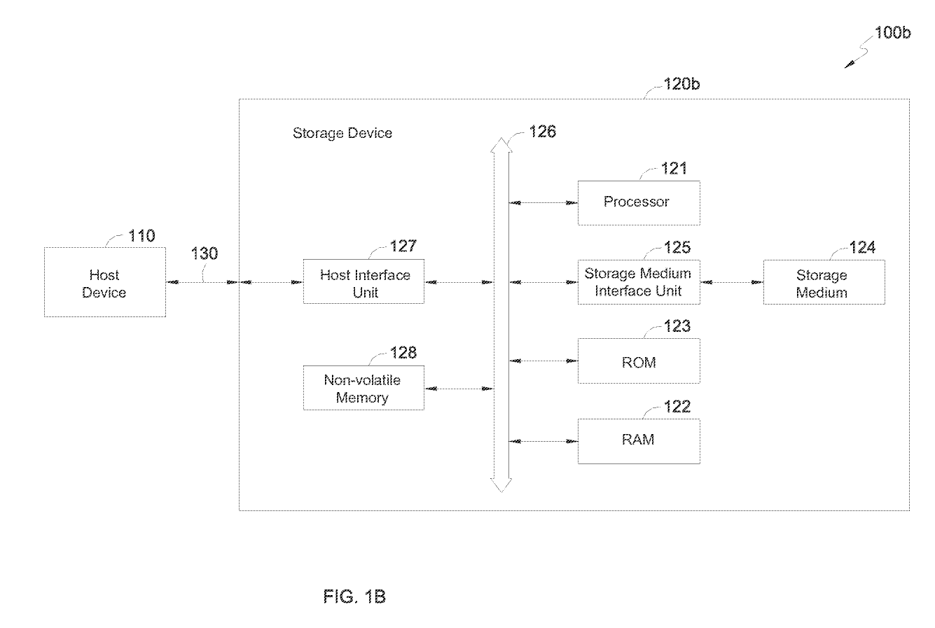

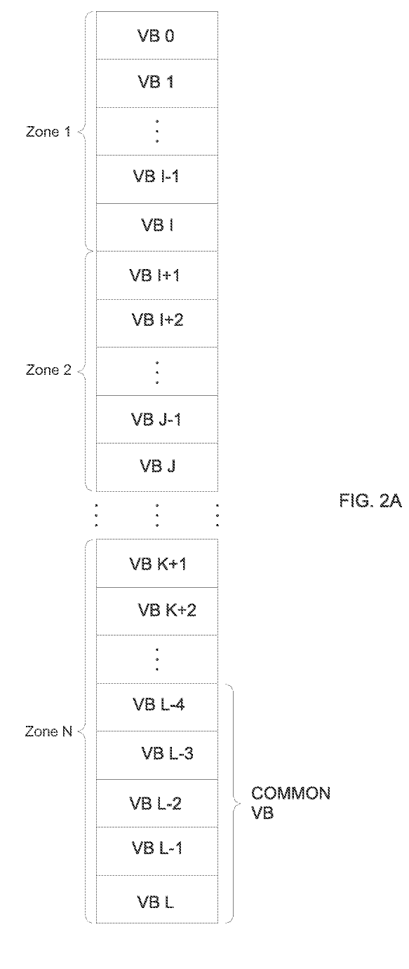

FIG. 10 is a view for explaining a software operating system in case where the storage device of FIG. 1A is a disk drive;

FIG. 11A is an electrical functional block diagram of a storage device in case where the storage device of FIG. 1A is a disk drive;

FIG. 11B is an electrical functional block diagram of a storage device in case where the storage device of FIG. 1B is a disk drive;

FIG. 12 is a configuration example illustrating a processor based on HTL;

FIG. 13 is a relational diagram illustrating queues contained in the second processor illustrated in FIG. 12;

FIG. 14 is another configuration example illustrating a processor contained in a storage device according to a preferred embodiment of the present invention;

FIG. 15 is a detailed functional block diagram illustrating a first check unit illustrated in FIG. 14;

FIG. 16 is a view for explaining the process of detecting a remaining area of the virtual band currently being used and an area-to-be-written thereof;

FIG. 17 is an operational flow chart illustrating a data write method according to a preferred embodiment of the present invention;

FIG. 18 is an operational flow chart illustrating the process of determining whether or not a writable area is insufficient in the zone in a data write method according to a preferred embodiment of the present invention;

FIG. 19 is an operational flow chart illustrating a data write method according to another preferred embodiment of the present invention;

FIG. 20 is an operational flow chart illustrating when generating a free virtual band in a data write method according to a preferred embodiment of the present invention;

FIG. 21 is a block configuration example illustrating a network system capable of performing a data write method according to preferred embodiments of the present invention; and

FIG. 22 is an operational flow chart illustrating a data write method according to a preferred embodiment of the present invention based on a network system illustrated in FIG. 21.

### DETAILED DESCRIPTION OF THE INVENTION

The accompanying drawings illustrating a preferred embodiment of the present invention and the content disclosed in the drawings should be referred to for the purpose of sufficiently understanding the present invention, operational advantages thereof, and the purpose accomplished by an embodiment of the present invention.

Hereinafter, the present invention will be described in detail by explaining preferred embodiments of the present invention with reference to the accompanying drawings. The same reference numerals disclosed in each drawing represents the same constituent elements.

FIG. 1A is a functional block diagram illustrating a host device—storage device based system 100a according to a preferred embodiment of the present invention. The host device—storage device based system 100a may be referred to as a computer system, but not limited to this.

Referring to FIG. 1A, the host device—storage device based system 100a may include a host device 110, a storage device 120a, and a communication link 130.

The host device 110 may perform an operation or process for generating a command for operating the storage device 120a to transmit it to the storage device 120a connected through the communication link 130, and transmitting data to the storage device 120a or receiving data from the storage device 120a according to the generated command.

The host device 110 may be a device, a server, a digital camera, a digital media player, a set-top box, a processor, a field programmable gate array, a programmable logic device, and/or any other suitable electronic device. The host device 110 may be integrated into the storage device 120a as a single body. The communication link 130 may be configured such that the host device 110 and storage device 120a are connected to each other via a wired communication link or wireless communication link.

In case where the host device 110 and storage device 120a are connected to each other via a wired communication link, the communication link 130 may be configured with a connector for electrically connecting an interface port of the host device 110 to an interface port of the storage device 120a. The connector may include a data connector and a power connector. For example, when a Serial Advanced Technology Attachment (SATA) interface is used between the host device 110 and storage device 120a, the connector may be configured with a 7-pin SATA data connector and a 15-pin SATA power connector.

In case where the host device 110 and storage device 120a are connected to each other via a wireless communication link, the communication link 130 may be configured on the basis of wireless communication such as Bluetooth or Zigbee.

The storage device 120a may write data received from the host device 110 onto the storage medium 124 or transmit data read from the storage medium 124 to the host device 110 according to a command received from the host device 110. The storage device 120a may be referred to as a data storage device or disk drive or disk system or memory device. When data is written on the storage medium 124 based on a shingled write operation which will be described later, the storage device 120a may be referred to as a shingled write disk system or shingled magnetic recording system.

Referring to FIG. 1A, the storage device 120a may include a processor 121, a random access memory (RAM) 122, a read only memory (ROM) 123, a storage medium 124, a storage medium information unit 125, a bus 126, and a host interface unit 127, but not limited to those elements. In other words, the storage device 120a may be configured with a larger number of elements than those elements illustrated in FIG. 1A or a smaller number of elements than those elements illustrated in FIG. 1A. For example, the processor 121, the RAM 122, and the host interface unit 127 as illustrated in FIG. 1A may be configured with one controller.

The processor 121 can interpret a command received from the host device 110 via the host interface unit 127 and bus 126, and control the elements of the storage device 120a according to the interpreted result. The processor 121 may include a code object management unit. Using the code object management unit, the processor 121 may load code objects stored in the storage medium 124 into the RAM 122. For example, the processor 121 may load code objects for implementing a data write method according to flow charts in FIGS. 17 through 20, which will be described later, stored in the storage medium 124 into the RAM 122.

The processor 121 may implement a task for a data write method according to flow charts in FIGS. 17 through 20 using the code objects loaded into the RAM 122. The data write method executed by the processor 121 will be described in detail in the description of FIGS. 17 through 20.

The ROM 123 may be stored with program codes and data required to operate the storage device 120a. The RAM 122 may be loaded with program codes and data stored in the ROM 123 based on the control of the processor 121.

The data stored in the ROM 123 may include management information on the storage medium 124 used in preferred embodiments of the present invention. The management information stored in the ROM 123 may be information based on the structure of the storage medium 124. For example, the management information may include information on virtual bands assigned to a plurality of zones contained in the storage medium 124 and information on at least one common virtual band which will be referred to in preferred embodiments of the present invention.

The virtual band contained in a zone may be referred to as a physical band (PB) or disk band (DB). The virtual band contained in a zone may be bands which are physically adjacent to one another on the storage medium 124 or bands which are not physically adjacent to one anther. The virtual band is a physical band that can be dynamically assigned to a logical block band (or logical address) received from the host device 110. The virtual band contained in a zone may be referred to as a band that can be assigned to a logical band for each zone.

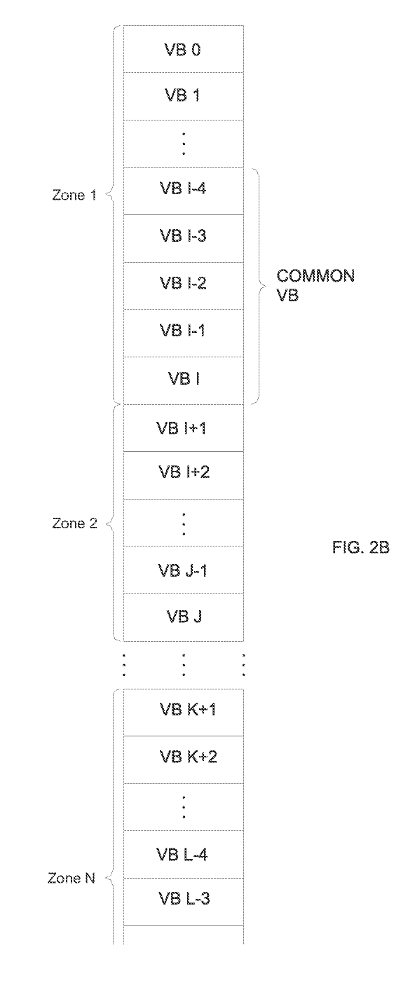

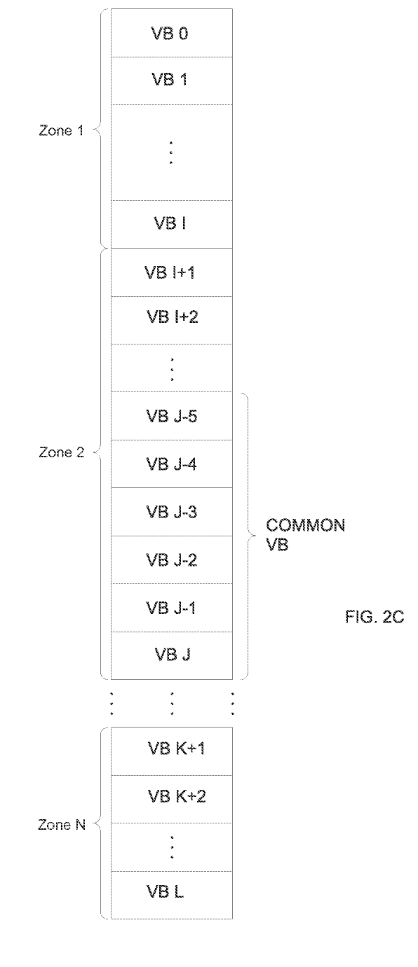

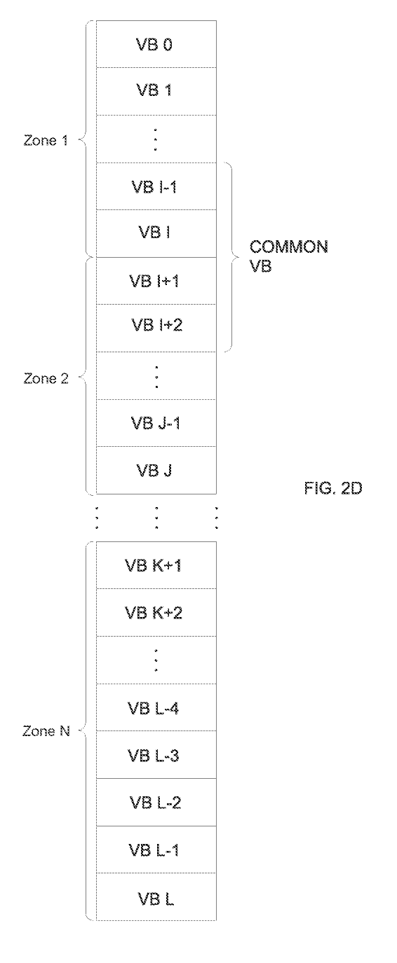

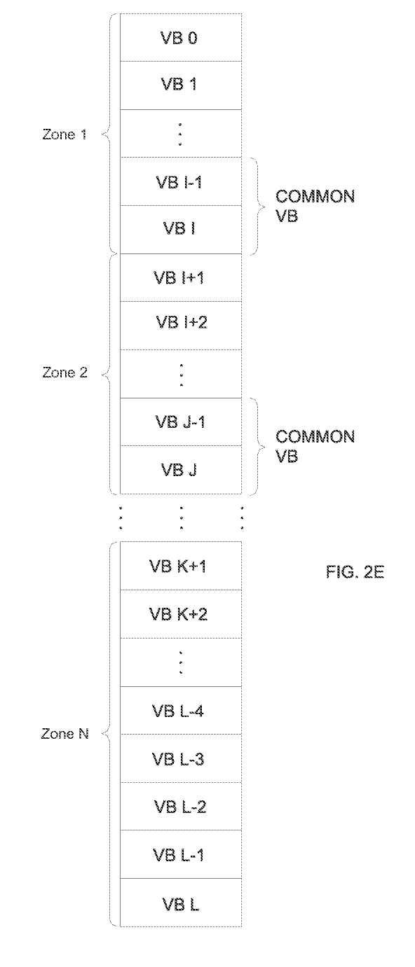

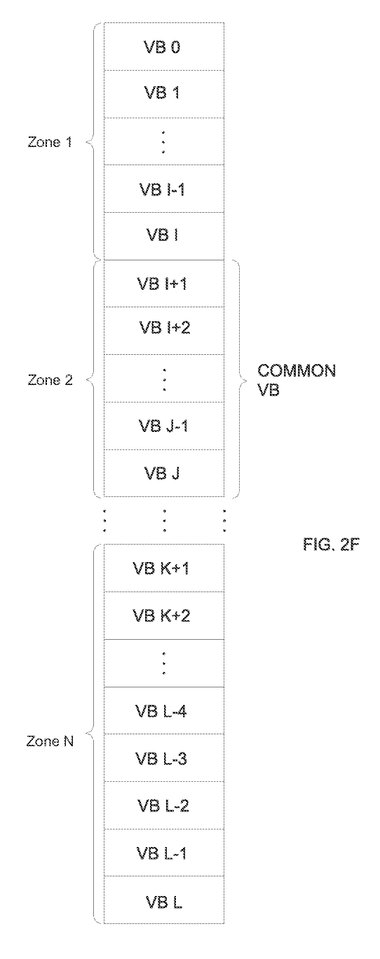

The common virtual band may be configured using at least one virtual band (or all virtual bands or some virtual bands) or at least one virtual band contained in at least two of the plurality of zones, respectively, contained in at least one of a plurality of zones on the storage medium 124, as examples illustrated in FIGS. 2A through 2F. Information on the common virtual band may be set in advance but also may be changed by a data write operation. The number of common virtual bands may be determined by a capacity of the storage medium 124.

FIG. 2A illustrates an example in which virtual bands (hereinafter, abbreviated as VBs) VB L−4˜VB L contained zone N among N zones are set to a common virtual band. FIG. 2B illustrates an example in which virtual bands VB I−4˜VB I contained zone 1 among N zones are set to a common virtual band. FIG. 2C illustrates an example in which virtual bands VB J−5˜VB J contained zone 2 among N zones are set to a common virtual band. FIG. 2D illustrates an example in which virtual bands VB I−1 and VB I contained zone 1 and virtual bands VB I+1 and VB I+2 contained zone 2 among N zones are set to a common virtual band. FIG. 2E illustrates an example in which virtual bands VB I−1 and VB I contained zone 1 and virtual bands VB J−1 and VB J contained zone 2 are set to a common virtual band. FIG. 2F illustrates an example in which all virtual band VB I+1˜VB J contained zone 2 are set to a common virtual band. In this manner, virtual bands that can be set to a common virtual band may be bands which are physically adjacent to one another, but may be also virtual bands which are not physically adjacent to one another. The number of virtual bands contained in N zones illustrated in FIGS. 2A through 2F may be the same but also a different number of virtual bands may be contained for each zone.

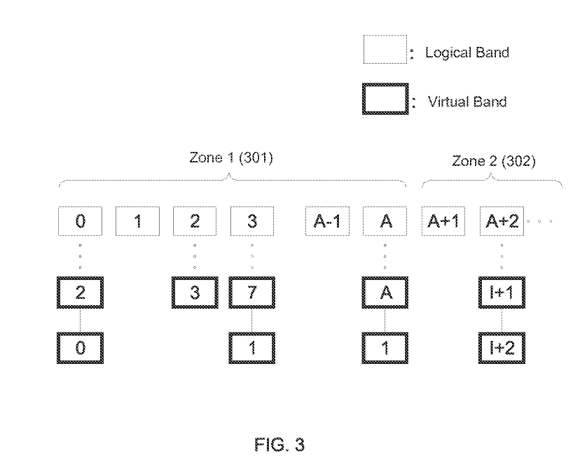

FIG. 3 is an exemplary view illustrating relations between a zone, a logical band and a virtual band on a storage medium 124. Referring to FIG. 3, zone 1 301 is an example in which “I” virtual bands are assigned to “A” logical bands.

The logical band in a zone is a band that can be divided into consecutive logical block addresses (LBAs). For example, assuming that an LBA range of the zone 1 301 is 0˜999 and 100 LBAs can be assigned to one logical band, “A” in the zone 1 301 is 10. In other words, 10 logical bands may be contained in the zone 1 301.

The zone 1 301 illustrates an example that “I” virtual bands the number of which is “α” greater than the number of logical bands are assigned thereto. The “α” virtual bands the number of which is greater than the number of logical bands may be referred to as reserved virtual bands in the zone 1 301. Accordingly, when the number of virtual bands is the same as that of logical bands, it may be construed that the relevant zone does not contain any reserved virtual bands. The virtual bands the number of which corresponds to the number of logical bands or data writable virtual bands among virtual bands the number of which corresponds to an integer multiple of the number of logical bands may be referred to as a remain virtual band or free virtual bands.

When a write command having an LBA range of 0˜99 corresponding to logical band “0” is received, data may be written onto virtual band “0” among the virtual bands contained in the zone 1 301. Even if “α” reserved virtual bands are assigned to the zone 1 301 when write commands having an LBA range of 0˜999 are intensively received, the reserved virtual bands as well as the virtual bands corresponding to the number of logical bands or an integer multiple may be all used, thereby resulting in an insufficient writable area.

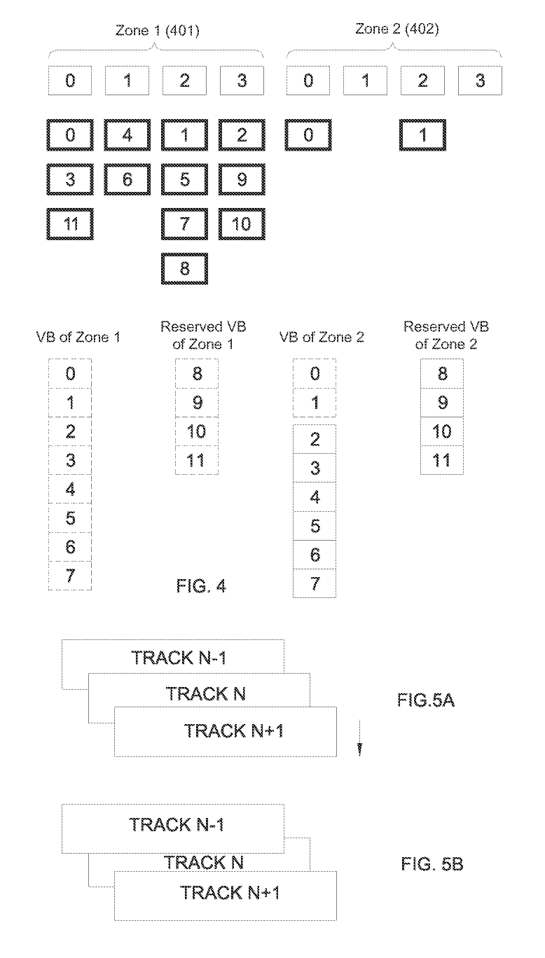

FIG. 4 is a comparative exemplary view illustrating a zone in which write commands are intensively received and a zone in which write commands are not intensively received. Referring to FIG. 4, in case of zone 1 401, 8 virtual bands corresponding to logical bands are assigned on the basis of 1:2 mapping and 4 reserved virtual bands are assigned but all virtual bands are used due to intensively receiving write commands. On the contrary, in case of zone 2 402, 8 virtual bands and 4 reserved virtual bands are assigned similarly to the zone 1 401 but two virtual band are used and ten virtual bands are remained.

In this manner, as write commands are intensively received with respect to the zone 1 401 though usable virtual bands are remained in the zone 2 402, merge operations for virtual bands in the zone 1 401 are continuously generated to secure free bands, thereby deteriorating the write operation performance of the storage device 120a, such as reducing a response speed for a write command of the host device 110. As an operation for securing a writable area, merge is an operation for writing data that has been written onto a valid sector contained in at least one virtual band having the largest number of invalid sectors, when at least one reserved virtual band exists in the relevant zone, into at least one reserved virtual band, and setting at least one virtual band having the largest number of invalid sectors to a free virtual band or free band. However, virtual bands in each zone may be typically managed to maintain at least three reserved virtual bands for the merge operation in the zone unit.

According to a preferred embodiment of the present invention, the storage medium 124 to which a common virtual band is set may be used in order to reduce the number of generations of the foregoing merge operation as illustrated in FIGS. 2A through 2F. The common virtual band is an area that can be commonly used when each zone contained in the storage medium 124 has an insufficient writable area.

In order to increase a write density, data may be written into each virtual band based on a shingled write operation. When data is written into each virtual band based on a shingled write operation, data may be written in an arrow direction into the tracks contained in a virtual band while being overlapped with a partial area of the previous track. Accordingly, during a shingled write operation in the virtual band unit, the write operation should be carried out only in one direction. When the storage medium 124 is a disk, data should be written only in an inner circumferential or outer circumferential direction thereof. It is due to a limiting condition as illustrated in FIGS. 5A and 5B. FIGS. 5A and 5B are views for explaining a limiting condition in case where data is written based on a shingled write operation.

Referring to FIG. 5A, when a shingled write operation is carried out in an arrow direction as illustrated in FIG. 5A, flux is generated only in the arrow direction. As a result, when data is written based on a shingled write operation, it should satisfy a limiting condition that writing data into track N−1 cannot be made subsequent to writing data to track N.

If writing data into track N−1 is made subsequent to writing data into track N in a direction opposite to the shingled write advancing direction, then data that has been written in track N will be erased by Adjacent Track Interference (ATI).

Accordingly, when data is written based on a shingled write operation, a technology of dynamically assigning a physical address of the storage medium 124 to a logical address received from the host device 110 may be required to always perform a data write operation in one direction on the storage medium 124.

HDD Translation Layer (HTL) is a technology proposed to satisfy a limiting condition when writing data based on the foregoing shingled write operation. The HTL converts a logical block address transmitted from the host device 110 into a virtual block address, and then converts the virtual block address into a physical block address of the storage medium 124, thereby accessing the storage medium 124. The physical block address may be a cylinder head sector (CHS), for example. The virtual block address is an address based on the physical location or physical block address of the storage medium 124, but may be also regarded as an address based on the physical location or physical block address dynamically assigned to the logical block address in order to satisfy a write condition in the foregoing one direction.

Program codes for implementing a data write method implemented by the processor 121 illustrated in FIGS. 17 through 20 may be stored in the ROM 123. The program codes for implementing the method stored in the ROM 123 may be loaded into the RAM 122 under the control of the processor 121 to be used. The RAM 122 and ROM 123 may be referred to as an information storage unit.

The storage medium 124 is a main storage medium of the storage device 120a, and media such as a disk or non-volatile semiconductor memory device may be used for the storage medium 124. Code objects for implementing a data write method according to flow charts in FIGS. 17 through 20, which will be described later, and the management information of the storage medium 124 may be stored in the storage medium 124 as described above. The management information stored in the storage medium 124 may include write status information for each of the plurality of zones in addition to management information stored in the ROM 123, information of virtual bands dynamically assigned in a plurality of zones, and information of a common virtual band.

The write status information for each of the plurality of zones may include a Mapping Table containing address mapping information for mapping a virtual address based on the physical address (PA) of the storage medium 124 to a logical address (LA) contained in a host command, and a Sector Allocation Table (SAT).

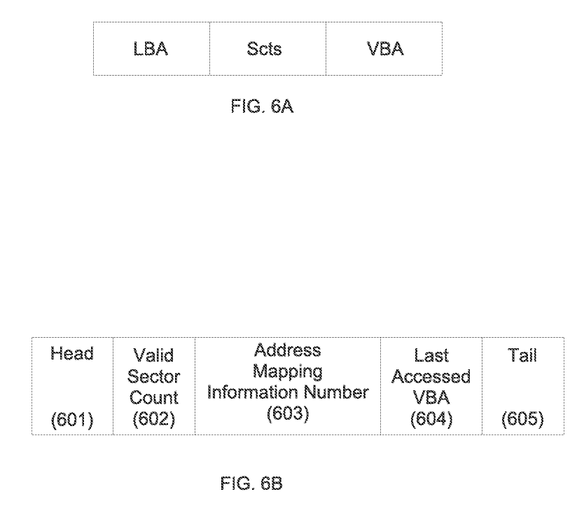

FIG. 6A is a schematic structural view of the Mapping Table, and FIG. 6B is a schematic structural view of the SAT.

Referring to FIG. 6A, the Mapping Table may include a logical block address (LBA) or logical address (LA) contained in a write command, a sector count (Scts) of data to be written, a virtual block address (VBA) or virtual address (VA) based on the physical address of the storage medium 124.

Referring to FIG. 6B, the SAT may include a first address mapping information (head) 601 of the virtual band, a valid sector count 602 for which valid data is written into the virtual band, an address mapping information number 603, a last accessed virtual block address (VBA) 604, last address mapping information (tail) 605 of the virtual band, but the SAT may not be limited to FIG. 6B. The first address mapping information 601 and last address mapping information 605 may be defined as address mapping information contained in the Mapping Table illustrated in FIG. 6A. The foregoing last accessed virtual block address may be referred to as a last accessed physical block address.

Furthermore, the write status information may include information to know the write status of the virtual band, such as the number of valid sectors to which valid data is written in the virtual band contained in each zone, the foregoing address mapping information of the valid sectors, and the number of invalid sectors to which invalid data is written, and the like. The foregoing management information may be referred to as meta-data or may be referred to as address aggregate information contained in the meta-data.

Management information stored in the storage medium 124 may be loaded into the RAM 122 to be used by the processor 121. If management information loaded into the RAM 122 to be used is updated by a write operation for the storage medium 124, then during power off, the updated management information may be written into an area to which the management information of the storage medium 124 can be written. The area to which the management information can be written may be an area corresponding to a maintenance cylinder area when the storage medium 124 is a disk, for example.

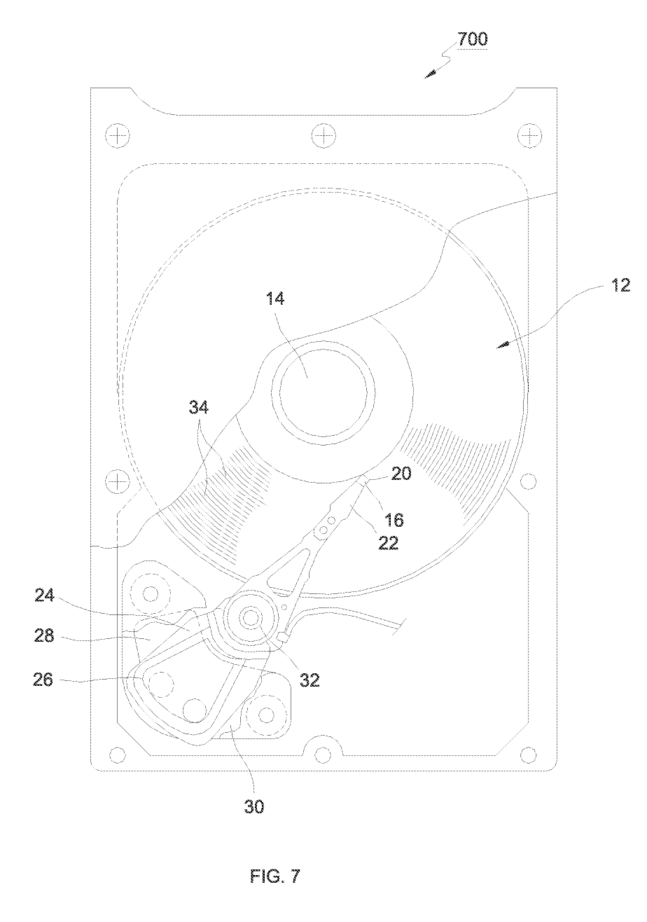

When the storage device 120a is a disk drive, a head disk assembly 700 may be defined as illustrated in FIG. 7.

FIG. 7 is a plan view illustrating the head disk assembly 700. Referring to FIG. 7, the head disk assembly 700 may include at least one disk 12 being rotated by a spindle motor 14. The disk 12 should be construed to correspond to the storage medium 124 in FIG. 1A. The head disk assembly 700 may include a head 16 located adjacent to a surface of the disk 12.

The head 16 may sense a magnetic field of each disk 12 and magnetize the disk 12, thereby reading data from the disk 12 being rotated or writing data to the disk 12. In general, the head 16 is coupled to a surface of the disk 12. FIG. 7 illustrates a single head 16, but it should be construed to include a write head for magnetizing the disk 12 and a read head for sensing a magnetic field of the disk 12. The read head may be configured with a magneto-resistive (MR) element. The head 16 may be referred to as a magnetic head or transducer.

The head 16 may be integrated into a slider 20. The slider 20 may be configured with the structure of generating an air bearing between the head 16 and the surface of the disk 12. The slider 20 is coupled to a head gimbal assembly 22. The head gimbal assembly 22 is adhered to an actuator arm 24 having a voice coil 26. The voice coil 26 is located adjacent to a magnetic assembly 28 to specify a voice coil motor (VCM) 30. A current supplied to the voice coil 26 generates a torque for rotating the actuator arm 24 with respect to a bearing assembly 32. The rotation of the actuator arm 24 moves the head 16 across a surface of the disk 12.

Data is typically written into a track 34 consisting of one circle on the disk 12. Each track 34 may include a plurality of sectors. The sectors contained in the track may be configured as illustrated in FIG. 8.

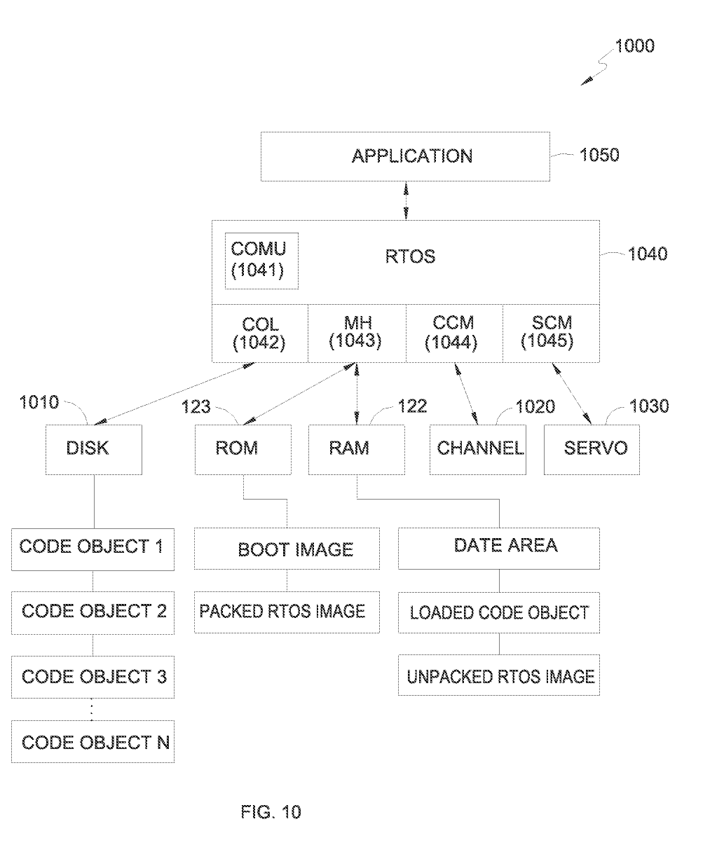

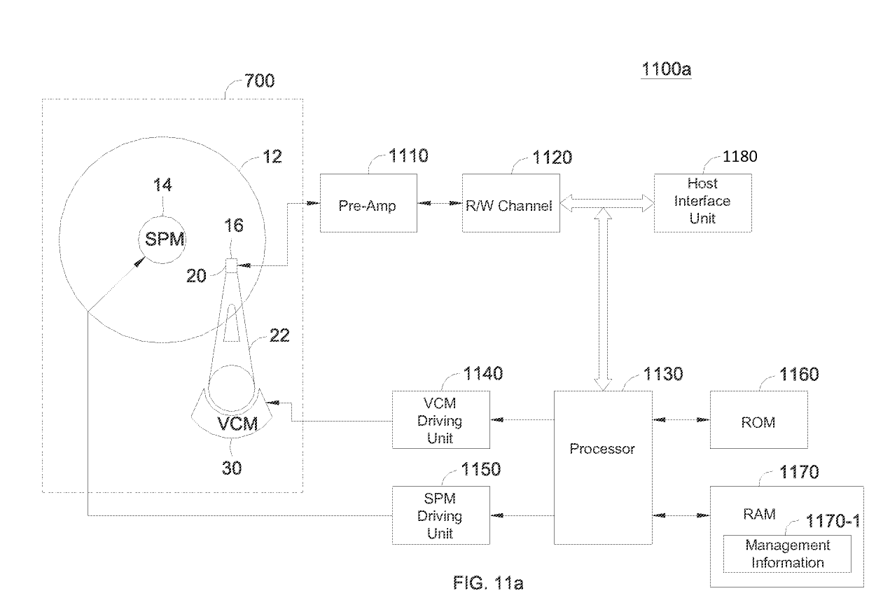

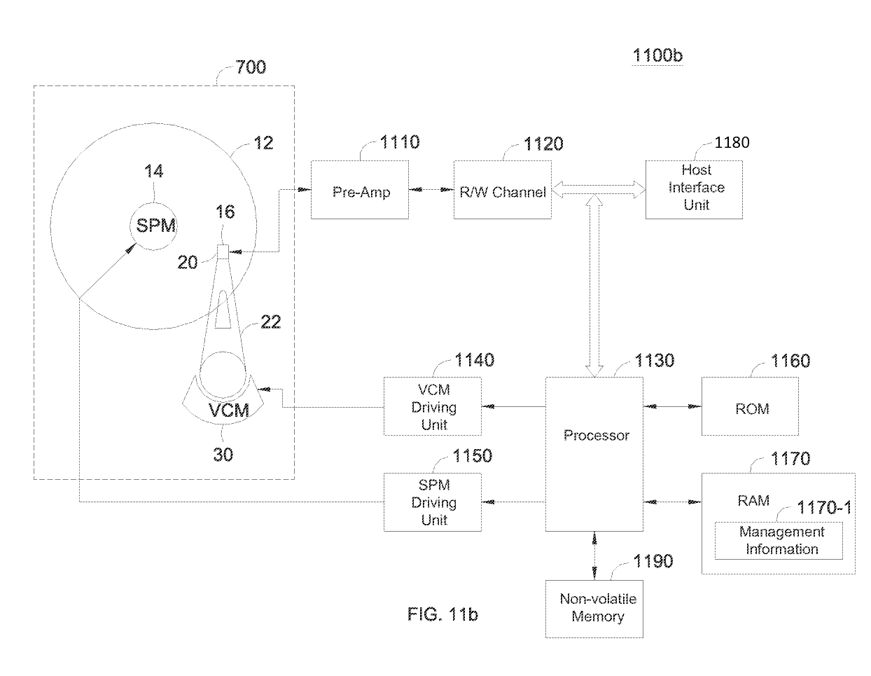

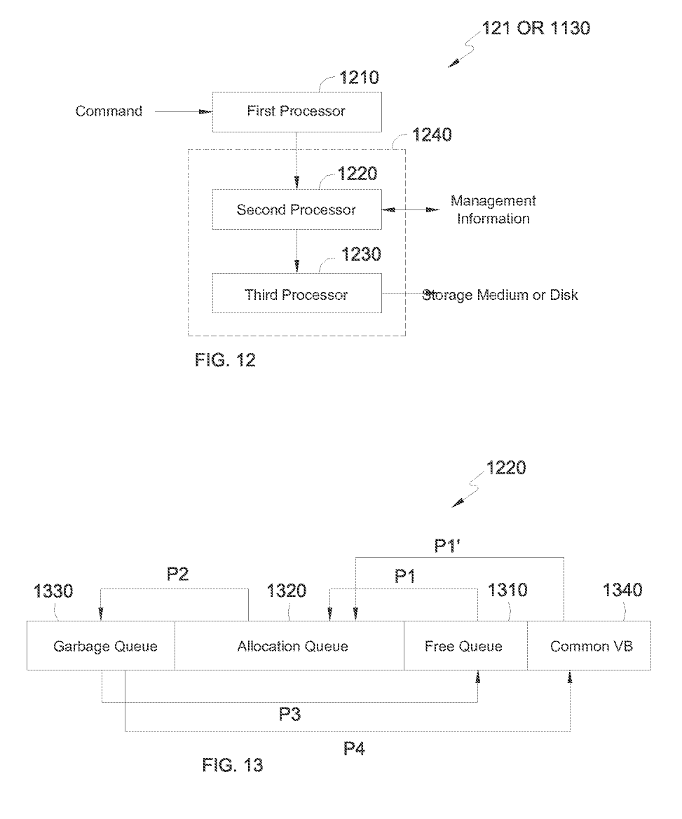

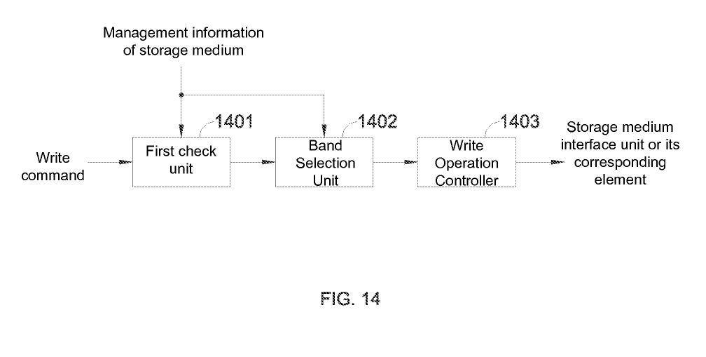

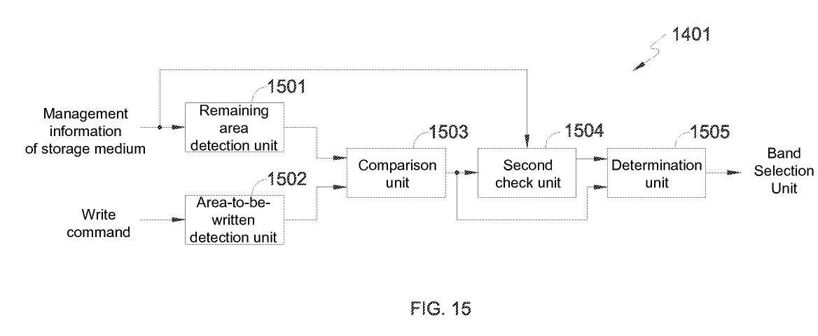

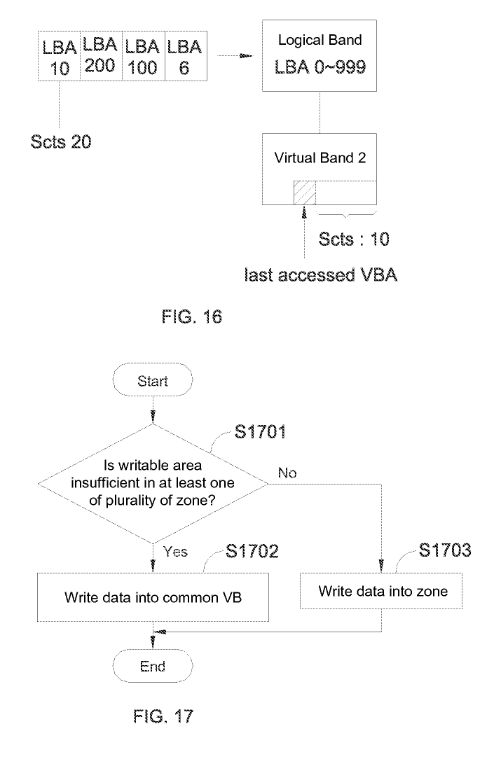

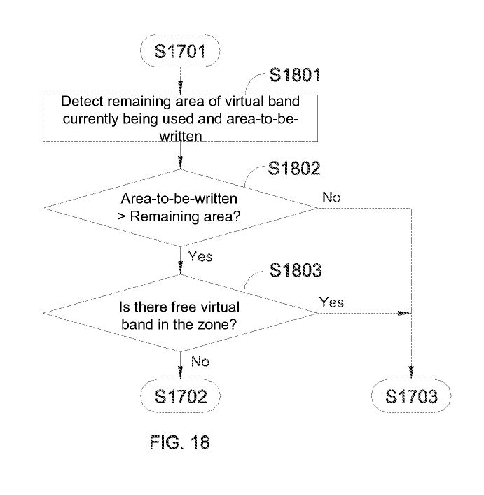

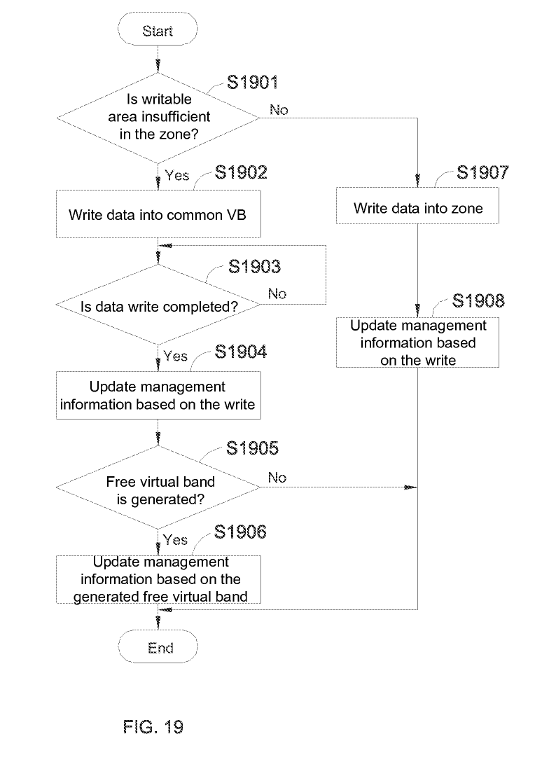

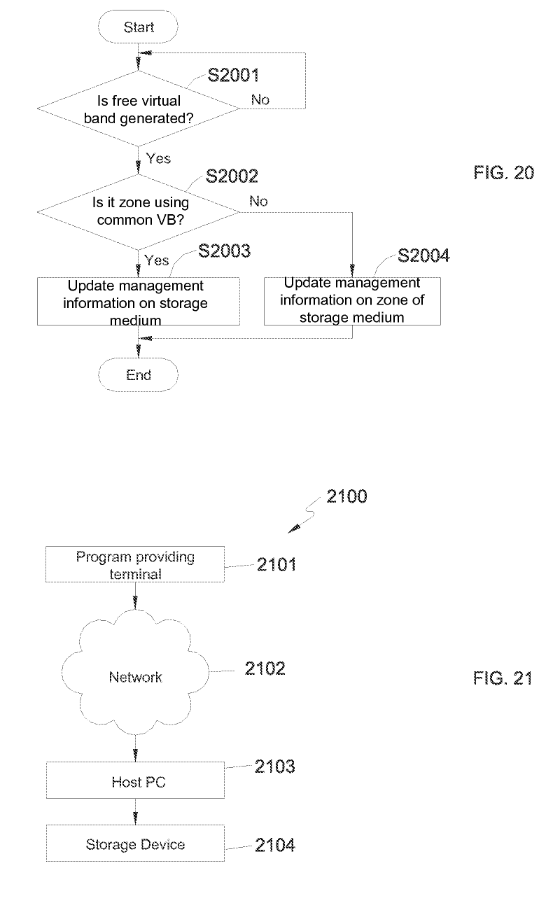

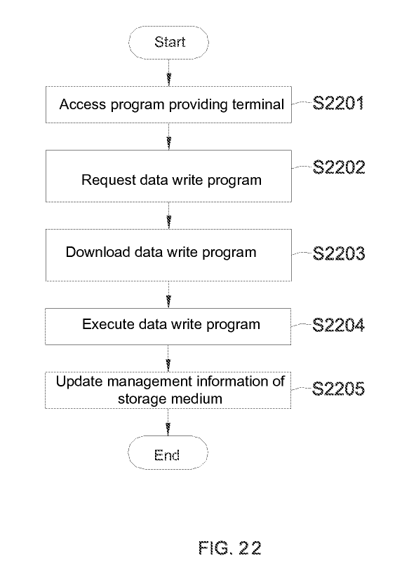

FIG. 8 is an example illustrating a sector architecture for one track of the disk 12. Referring to FIG. 8, one servo sector interval (T) may include a servo area (S) and a plurality of data sectors (Ds). However, the track may be configured such that a single data sector (D) is contained in one servo sector interval (T). The data sector (D) may be referred to as a sector. Specifically, signals as illustrated in FIG. 9 may be written into the servo area (S).

FIG. 9 is an example illustrating the structure of a servo area (S) illustrated in FIG. 8. Referring to FIG. 9, a preamble 901, a servo synchronization indication signal 902, a gray code 903, and a burst signals 904 are written into the servo area (S). The preamble 901 may be used to provide clock synchronization when reading servo information, provide a constant timing margin with a gap prior to the servo sector, and determine a gain of the auto gain control circuit. The servo synchronization indication signal 902 may include a servo address mark (SAM) and a servo index mark (SIM). The servo address mark is a signal indicating a start of the servo sector. The servo index mark is a signal indicating a start of the first servo sector in a track.

The gray code 903 provides track information. The burst signal 904 is a signal used to control the head 16 to follow the center of the track 34. For example, the burst signal 904 may be may be configured with four patterns (A, B, C, D). In other words, a position error signal used during a track-follow control may be generated by combining those four burst patterns.

The disk 12 may be divided into a maintenance cylinder area that is inaccessible by the user and a user data area that is accessible by the user. The maintenance cylinder area may be also referred to as a system area. Various information required for the control of a disk drive is stored in the maintenance cylinder area. For example, the maintenance cylinder area may be configured in the most outer circumferential area of the disk 12. For example, information required to perform a data write method according to a preferred embodiment of the present invention may be stored in the maintenance cylinder area. For example, the management information of the storage medium 124 referred to in a preferred embodiment of the present invention may be stored in the maintenance cylinder area.

The head 16 moves across a surface of the disk 12 to read data from another track or write data into another track. A plurality of code objects for implementing various functions using a disk drive may be stored in the disk 12. For example, a code object for implementing an MP3 player function, a code object for implementing a navigation function, a code object for implementing various video games, and the like may be stored in the disk 12.

Referring to FIG. 1A, a storage medium interface unit 125 is an element for allowing the processor 121 to access the storage medium 124 and perform a data write process or read data process. When the storage device 120a is a disk drive, the storage medium interface unit 125 may include a servo circuit for controlling the head disk assembly 700 and a read/write channel circuit for performing a signal processing for data read and/or write.

In particular, according to a preferred embodiment of the present invention, whenever the zone lacks a writable area, the storage medium interface unit 125 may be controlled by the processor 121 to move the magnetic head 16 so as to write data into at least one common virtual band of the storage medium 124, and when the zone does not lacks a writable area, the storage medium interface unit 125 may be controlled by the processor 121 to move the magnetic head 16 so as to write data into a virtual band contained in the relevant zone of the storage medium 124.

A host interface unit 127 in FIG. 1A may perform a data transmission and/or reception processing between the host device 110 and the storage device 120a. The host interface unit 127 may be configured based on the communication link 130.

The bus 126 may transfer information between the elements of the storage device 120a.

When the storage device 120a is a disk drive, a software operating system of the storage device 120a may be defined as illustrated in FIG. 10. FIG. 10 is a view for explaining a software operating system in case where the storage device of FIG. 1A is a disk drive.

Referring to FIG. 10, a plurality of code objects (1˜N) are stored in a disk or disk 1010 corresponding to the storage medium 124 of FIG. 1A. Code objects written onto the disk 1010 may include code objects required for the operation of the disk drive and code objects associated with various functions using the disk drive.

In particular, code objects for implementing a data write method according to flow charts in FIGS. 17 through 20 may be written onto the disk 1010 in order to implement preferred embodiments of the present invention. The code objects for implementing a data write method according to flow charts in FIGS. 17 through 20 may be stored in the ROM 123 instead of the disk 1010. Code objects for performing various functions such as an MP3 player function, a navigation function, a video game function, and the like may be also stored in the disk 1010.

A boot image and a packed RTOS image are stored in the ROM 123 in FIG. 1A. During the booting process, an unpacked ROS image is loaded into the RAM 122 by reading a boot image from the ROM 123. Then, code objects required to perform a host interface stored in the disk 1010 are loaded into the RAM 122. A data area for storing data is also assigned to the RAM 122. Circuits required to perform a signal processing for reading and/or writing data are incorporated into the channel circuit 1020. A servo circuit 1030 may include circuits required to control the head disk assembly 700 in order to perform a data read operation or data write operation.

A real time operating system (RTOS) 1040 is a real-time operating system program, which is a multi program operating system using the disk 1010. According to a task, real-time multi processing is performed in a foreground routine with a high priority and batch processing is performed in a background routine with a low priority. The RTOS 1040 may perform loading of code objects from the disk 1010 and unloading of code objects to the disk 1010.

The RTOS 1040 manages a code object management unit (COMU) 1041, a code object loader (COL) 1042, a memory handler (MH) 1043, a channel control module (CCM) 1044, and a servo control module (SCM) 1045 to perform a task according to a requested command. Furthermore, the RTOS 1040 manages application programs 1050. The RTOS 1040 loads code objects required to control a disk drive into the RAM 130 during the booting process of the disk drive. Accordingly, after booting is carried out, the code objects loaded into the RAM 130 may be used to operate the disk 1010. Furthermore, when the disk 1010 is a shingled write disk, the RTOS 1040 may be operated based on the foregoing HDD Translation Layer (HTL) illustrated in FIGS. 5A and 5B.

The COMU 1041 performs processing for storing information on the location at which code objects are written, and arbitrating the bus 126. Also, information on the priorities of tasks being executed is stored therein. In addition, the COMU 1041 manages task control block (TCB) information and stack information required to execute tasks with respect to code objects.

The COL 1042 performs processing for loading code objects stored in the disk 1010 to the RAM 122 and unloading the code objects stored in the RAM 122 to the disk 1010 by using the COMU 1041. Accordingly, the COL 1042 may load code objects for implementing a data write method according to flow charts in FIGS. 17 through 20 into the RAM 122.

The RTOS 1040 may implement a method according to flow charts in FIGS. 17 through 20, which will be described below, using the code objects loaded into the RAM 122. The MH 1043 performs processing for writing and reading data into and from the ROM 123 and the RAM 122. The CCM 1044 performs channel control required to execute a signal processing of data read and write. The SCM 1045 performs servo control including the head disk assembly 700 to execute data read and write.

On the other hand, FIG. 1B is a functional block diagram illustrating a host device—storage device 100b based system according to another preferred embodiment of the present invention.

Referring to FIG. 1B, the storage device 120b may include a non-volatile memory 128 in addition to the storage device 120a of FIG. 1A. In FIG. 1B, the storage medium 124 may be implemented by a disk.

The non-volatile memory 128 may be implemented by a non-volatile semiconductor memory, for example, a flash memory, a phase change RAM (PRAM), a ferroelectric RAM (FRAM), a magnetic RAM (MRAM), and the like.

Part or all of data to be stored in the storage device 120b may be stored in the non-volatile memory 128. For example, various information required to control the storage device 120b may be stored in the non-volatile memory 128.

Furthermore, program codes and information for implementing a method according to flow charts in FIGS. 17 through 20 may be stored in the non-volatile memory 128. In addition, a mapping table for converting a logical block address into a virtual block address based on a virtual zone or virtual band and information on the foregoing common VB as illustrated in FIGS. 2A through 2F may be stored in the non-volatile memory 128. Furthermore, code objects for implementing various functions of the storage device 120b may be stored in the non-volatile memory 128. When the mapping table and the foregoing program codes and information are stored in the non-volatile memory 128, the storage device 120b may be used by loading the mapping table and the foregoing program codes and information into the RAM 122.

FIG. 11A is an electrical functional block diagram of the storage device 120a in case where the storage device of FIG. 1A is a disk drive.

Referring to FIG. 11A, a disk drive 1100a according to an embodiment of the storage device 120a may include a head disk assembly 700, a pre-amplifier 1110, a read/write (R/W) channel 1120, a processor 1130, a voice coil motor (VCM) driving unit 1140, a spindle motor (SPM) driving unit 1150, a ROM 1160, a RAM 1170, and a host interface unit 1180. The disk drive 1100a is not limited to the configuration illustrated in FIG. 11A.

The processor 1130 may be a digital signal processor (DSP), a microprocessor, a microcontroller, and the like, but not limited to them. The processor 1130 controls the read/write channel 1120 to read data from the disk 12 or write data onto the disk 12 according to a command received from the host device 110 through the host interface 1180.

The processor 1130 is coupled to the VCM driving unit 1140 that supplies a driving current for driving the voice coil motor (VCM) 30. The processor 1130 may supply a control signal to the VCM driving unit 1140 in order to control the motion of the head 16.

The processor 1130 is also coupled to the spindle motor (SPM) driving unit 1150 that supplies a driving current for driving the spindle motor (SPM) 14. When power is supplied, the processor 1130 supplies a control signal to the SPM driving unit 1150 in order to rotate the spindle motor 14 at a target speed.

The processor 1130 is coupled to the ROM 1160 and the RAM 1170, respectively. Firmware and control data for controlling the disk drive 1100a are stored in the ROM 1160. The program codes and information for implementing a method according to flow charts in FIGS. 17 through 20 may be stored in the ROM 1160 or stored in a maintenance cylinder area of the disk 12.

In an initialization mode, program codes stored in the ROM 1160 or the maintenance cylinder area of the disk 12 under the control of the processor 1130 may be loaded to the RAM 1170. Data received from the host interface unit 1180 or data read from the disk 12 may be temporarily stored in the RAM 1170. The management information 1170-1 on the disk 12 that has been read from the ROM 1160 or the maintenance cylinder area of the disk 12 by the processor 1130 is loaded to the RAM 1170 to be used by the processor 1130. The management information 1170-1 is the same as the foregoing management information. The management information 1170-1 may be updated according to a write operation or merge operation to the disk 12. The RAM 1170 may be implemented by a dynamic random access memory (DRAM) or static random access memory (SRAM). The RAM 1170 may be designed to be driven in a single data rate (SSR) or double data rate (DSR) scheme.

The processor 1130 may control the disk drive 1100 to implement a data write method according to flow charts in FIGS. 17 through 20 using program codes and information stored in the ROM 1160 or the maintenance cylinder area of the disk 12. In particular, the processor 1130 may move the magnetic head 16 to at least one common virtual band of the disk 12 to perform a data write operation when at least one zone contained in the disk 12 lacks a writable area, and move the magnetic head 16 to the zone to perform a data write operation when a zone contained in the disk 12 corresponding to a logical address contained in the write command does not lack a writable area.

The data read operation and data write operation of the disk drive 1100a will be described below.

During the data read operation, the disk drive 1100a amplifies an electrical signal sensed by the head 16 from the disk 12 in the pre-amplifier 1110. The read/write channel 1120 converts a signal outputted from the pre-amplifier 1110 into a digital signal, and decode it to detect data.

The read/write channel 1120 may temporarily store the signal outputted from the pre-amplifier 1110. The decoded and detected data is error-corrected using an error correction code such as the Reed-Solomon code in the processor 1130, and then converted into stream data. The stream data is transmitted to the host device 110 via the host interface unit 1180.

During the data write operation, the disk drive 1100a receives data from the host device 110 via host interface unit 1180. The processor 1130 may add an error correction symbol generated by the Reed-Solomon code to the received data. The data to which an error correction symbol generated by the Reed-Solomon code is added by the read/write channel 1120 is encoded to be suitable to the write channel. The data encoded by the pre-amplifier 1110 is written onto the disk 12 through the head 16 with an amplified write current.

The RAM 1170 and ROM 1160 in FIG. 11A may be referred to as one information storage unit. The structure of the disk 12 may write data as illustrated in FIGS. 5A and 5B.

When the processor 1130 is operated based on the HTL, the processor 1130 converts a logical block address received from the host device 110 into a virtual block address as in the foregoing processor 121. Next, the processor 1130 converts a virtual block address into a physical block address of the disk 12 to write data onto the disk 12 or read data from the disk 12.

When the processor 1130 is operated based on the HTL, the processor 1130 may be configured as illustrated in FIG. 12. FIG. 12 is a configuration example illustrating the processor 1130 based on the HTL, but the processor 121 contained in the storage device 100a of FIG. 1A may be also configured as illustrated in FIG. 12 in case where the processor 121 is based on the HTL. Accordingly, it will be construed that the following description is similarly applied to the processor 121.

Referring to FIG. 12, the processor 1130 may include a first processor 1210, a second processor 1220, and a third processor 1230. Here, the second processor 1220 and third processor 1230 may be designed to be incorporated into one processor 1240. Of course, though not shown in the drawing, the first process 1210 and second processor 1220 may be designed to be incorporated into one processor.

The first processor 1210 may perform the operation of receiving a command from the host device 110 and extracting a logical block address from the received command.

The second processor 1220 may perform the operation of converting a logical block address extracted from the first processor 1210 into a virtual block address. In other words, the second processor 1220 may convert a logical block address into a virtual block address based on each zone or at least one common VB using the management information 1170-1 of the disk 12 stored in the RAM 1170.

In other words, if it is determined that a zone corresponding to the logical block address lacks a writable area based on the management information 1170-1 of the disk 12, then the second processor 1220 converts a logical block address into a virtual block address based on at least one common VB. On the contrary, if the zone does not lack a writable area, the second processor 1220 converts a logical block address into a virtual block address based on the zone.

In order to perform the foregoing address conversion operation, the second processor 1220 may manage information of virtual bands of the storage medium 124 or disk 12 using a free queue 1310, an allocation queue 1320, a garbage queue 1330, and a common virtual band queue 1340 as illustrated in FIG. 13.

FIG. 13 is a relational diagram illustrating queues contained in the second processor 1220. For the sake of convenience of explanation, an example applied to the disk 12 will be described below but it should be construed that the following description is similarly applied to the storage medium 124.

The free queue 1310 illustrated in FIG. 13 may store information on free virtual bands that can be used for each zone in the disk 12. The free virtual band may be referred to as a physical band or disk band, but hereinafter it will be referred to as a free virtual band for the sake of convenience of explanation. It is because bands contained in a zone may not be physically adjacent to one another as described above. As a virtual band that is not yet assigned to any logical band, the free virtual band is a virtual band in which there exists no valid sector. In other words, it may be construed to be a virtual band into which any valid data is not written.

As a virtual band that does not contain any sector into which valid data is written as described above, the free virtual band the information of which is stored in the free queue 1310 may be used as a virtual band into which data can be written. The free virtual band the information of which is stored in the free queue 1310 may be referred to as a reserved virtual band, but hereinafter will be referred to as a free virtual band to distinguish it from a common VB.

The allocation queue 1320 illustrated in FIG. 13 may store information on virtual bands used for each zone of the disk 12 or currently being used. The foregoing virtual bands used or currently being used are virtual bands assigned to one of logical bands corresponding to the zone. The information of virtual bands registered in the allocation queue 1320, as the information of free virtual bands selected from free virtual bands registered in the free queue 1310 according to the received write command, is registered in the allocation queue 1320 when data is written (P1).

The garbage queue 1330 may store information on virtual bands used for each zone of the disk 12 or being used. However, the virtual bands the information of which are stored in the garbage queue 1330 may be used as virtual bands to be merged during a merge operation for securing a writable area. The virtual bands the information of which are stored in the garbage queue 1330 are virtual bands having the largest number of invalid data sectors in the zone. Accordingly, when virtual bands are selected according to the number of invalid data sectors from the information of virtual bands registered in the allocation queue 1320, the information of the selected virtual bands is registered in the garbage queue 1330 (P2).

The common VB queue 1340 may store the information of common virtual bands that can be commonly used when a writable area is insufficient in a plurality of zones of the disk 12. For example, when there is no free virtual band assigned to a specific zone in the free queue 1310, new virtual bands can be assigned to the specific zone based on the information of at least one common VB stored in the common VB queue 1340.

In other words, if at least one common virtual band is selected based on the common VB queue 1340 and data is written thereto, then information on a common VB for which the data is written to the allocation queue 1320 is registered as a virtual band assigned to the specific zone (P1′).

When a merge in the zone to which virtual bands are assigned based on the information of at least one common VB in the common VB queue 1340 is generated to generate free virtual bands, the information of the generated free virtual bands may be registered in the common VB queue 1340 through a line (P4). However, it may be also implemented such that the generated free virtual bands are registered in the common VB queue 1340 (P4) only when they are virtual bands that have been registered in the common VB queue 1340, and the generated free virtual bands are registered in the free queue 1310 (P3) when the generated free virtual bands are virtual bands that have been previously assigned to the relevant zone.

The second processor 1220 may manage the free queue 1310, allocation queue 1320, garbage queue 1330, and common VB queue 1340 for each disk 12 or unit, and manage the information of virtual bands stored in the free queue 1310, allocation queue 1320, and garbage queue 1330 for each zone. The unit may include a plurality of zones.

The third processor 1230 of FIG. 12 may manage the management information 1170-1 stored in the RAM 1170, and control the R/W channel 1120, pre-amplifier 1110, VCM driving unit 1140, and SPM driving unit 1150 in FIG. 11A to write data according to a preferred embodiment of the present invention. In case of the processor 121, it may control the storage medium interface unit 125 to write data according to a preferred embodiment of the present invention.

FIG. 11B is an electrical functional block diagram of the storage device 120b when the storage device of FIG. 1B is a disk drive.

The disk drive 1100b as illustrated in FIG. 11B may include a non-volatile memory 1190 in addition to the disk drive 1100a as illustrated in FIG. 11A. Part of data to be stored in the disk drive 1100b may be stored in the non-volatile memory 1190. For example, various information required to control the disk drive 1100b may be stored in the non-volatile memory 128.

Furthermore, program codes and information for implementing a method according to flow charts in FIGS. 17 through 20 may be stored in the non-volatile memory 1190. Specifically, a mapping table for converting a logical block address into a virtual block address based on a virtual zone or virtual band, and information on the common VB and the VB assigned to each zone may be stored in the non-volatile memory 1190. Furthermore, code objects for implementing various functions of the disk drive 1100b may be stored in the non-volatile memory 1190.

The processor 1130 is coupled to the ROM 1160, the RAM 1170, and the non-volatile memory 1190, respectively. Firmware and control data for controlling the disk drive are stored in the ROM 1160. The program codes and information for implementing a method according to flow charts in FIGS. 17 through 20 may be stored in the ROM 1160. Of course, the program codes and information for implementing a method according to flow charts in FIGS. 17 through 20 may be also stored in a maintenance cylinder area of the disk 12 or the non-volatile memory 1190 instead of the ROM 1160.

In an initialization mode, the program codes and information stored in the ROM 1160, the disk 12 or the non-volatile memory 1190 may be loaded to the RAM 1170 under the control of the processor 1130.

The redundant description of the same elements that have been previously described in the disk drive 1100a of FIG. 11A will be omitted herein.

According to a preferred embodiment of the present invention, when receiving the write command, the processor 121, 1130 may be configured as illustrated in FIG. 14 in order to control a data write operation to be carried out in at least one common VB when a zone of the storage medium 124 or disk 12 corresponding to a logical address contained in a write command lacks a writable area, and control the data write operation to be carried out in the zone when the zone does not lack a writable area.

FIG. 14 is another configuration example illustrating the processor 121, 1130 contained in the storage device 120 according to a preferred embodiment of the present invention. For the sake of convenience of explanation, an example of operation that can be carried out by the processor 1130 will be described below. However, it should be construed that the following operation can be also carried out by the processor 121.

Referring to FIG. 14, the processor 1130 may include a first check unit 1401, a band selection unit 1402, and a write operation controller 1403.

If a write command is received from the host device 110 via the host interface unit 1180, then the first check unit 1401 checks whether or not a writable area is insufficient in the zone of the disk 12 corresponding to the write command based on the management information 1170-1 of the disk 12 stored in the RAM 1170.

The first check unit 1401 may be configured as illustrated in FIG. 15. FIG. 15 is a detailed functional block diagram illustrating the first check unit 1401 illustrated in FIG. 14.

Referring to FIG. 15, the first check unit 1401 may include a remaining area detection unit 1501, an area-to-be-written detection unit 1502, a comparison unit 1503, a second check unit 1504, and a determination unit 1505.

The remaining area detection unit 1501 detects a remaining area of the virtual band currently being used in a zone corresponding to the write command based on the management information 1170-1 of the disk 12 stored in the RAM 1170.

The detection of a remaining area will be described with reference to an example illustrated in FIG. 16. FIG. 16 is a view for explaining the process of detecting a remaining area of the virtual band currently being used and an area-to-be-written thereof. Referring to FIG. 16, it is illustrated a case that the sector count of the remaining area of the virtual band currently being used is 10 when the sector count of a write command currently being received is 20 and the LBA is 10. The remaining area may be detected by subtracting a last accessed virtual block address (VBA) in virtual band 2 from a total sector count of the virtual band 2 currently being used. Information on the detected remaining area of the virtual band currently being used is transmitted to the comparison unit 1503.

The area-to-be-written detection unit 1502 detects an area-to-be-written from the received write command. In other words, the area-to-be-written may be detected based on a sector count contained in the write command currently being received. In case of FIG. 16, the area-to-be-written is 20 sectors. The information of the detected area-to-be-written is transmitted to the comparison unit 1503.

The comparison unit 1503 compares the remaining area information (usable sector count) detected in the remaining area detection unit 1501 with the area information (sector count required during a write operation) detected in the area-to-be-written detection unit 1502 to output the comparison result.

If a signal indicating that the area-to-be-written is greater than the remaining area of the virtual band currently being used is output, then the second check unit 1504 checks whether or not the zone has a free virtual band based on the management information 1170-1 of the disk 12, and transmit the check result to the determination unit 1505. Checking whether or not the zone has a free virtual band may be construed to include checking whether or not there exists a remain virtual band (VB) in the zone and checking whether or not there exists a reserved virtual band (VB). The foregoing check of existence or non-existence may be carried out using the management information 1170-1.

The determination unit 1505 transmits a signal through which whether or not a writable area is insufficient in the relevant zone is determined based on the output signal of the comparison unit 1503 and the output signal of the second check unit 1504 to the band selection unit 1402.

In other words, if a signal output from the comparison unit 1503 indicates that the area-to-be-written is not greater than the remaining area of the virtual band currently being used, and indicates that there exists no free virtual band as a result of checking in the second check unit 1504, then a signal through which a writable area is insufficient in the zone is output.

However, if a signal output from the comparison unit 1503 indicates that the area-to-be-written is greater than the remaining area of the virtual band currently being used, but indicates that there exists a free virtual band as a result of checking in the second check unit 1504 or the signal output from the comparison unit 1503 indicates that the area-to-be-written is not greater than the remaining area of the virtual band currently being used, then the 1505 outputs a signal through which a writable area is not insufficient in the zone.

The determination unit 1505 may output a signal through which the foregoing two cases can be distinguished from each other when outputting a signal through which it is determined that the zone does not lack a writable area. In other words, the determination unit 1505 may output a determination signal capable of distinguishing a case where the area-to-be-written is greater than the remaining area of the virtual band currently being used but the relevant zone has a free virtual band from a case where the area-to-be-written is not greater than the remaining area of the virtual band currently being used by the output signals of the comparison unit 1503 and second check unit 1504.

If it is determined by the first check unit 1401 that the writable area is insufficient, then the band selection unit 1402 of FIG. 14 selects one of a plurality of common VBs based on the management information 1170-1 of the disk 12 and transmits information on the selected common VB to the write operation controller 1403.

If it is determined by the first check unit 1401 that the writable area is not insufficient, then the band selection unit 1402 does not perform the operation of selecting a common VB, and thus any data may not be transmitted to the write operation controller 1403.

However, when two cases are distinguished and output by a signal through which it is determined that the writable area is not insufficient from the first check unit 1401 as described above, and a free virtual band should be selected in the relevant zone according to the outputted determination signal, the band selection unit 1402 may select a free virtual band in the relevant zone by referring to the management information 1170-1, and transmit information on the selected free virtual band to the write operation controller 1403.

The write operation controller 1403 of FIG. 14 may control elements including the R/W channel 1120, VCB driving unit 1140, and SPM driving unit 1150 that are required for a write operation to perform a data write operation in the free virtual band selected by the band selection unit 1402. In case of the processor 121 of FIG. 1, it may control the storage medium interface unit 125. Accordingly, it may be construed that the foregoing elements correspond to the storage medium interface unit 125.

If any band selection information is not received from the band selection unit 1402, then the write operation controller 1403 may control the foregoing elements to perform the foregoing data write operation in the virtual band currently being used.

FIG. 17 is an example of the operational flow chart illustrating a data write method according to a preferred embodiment of the present invention. The following description will be described based on the processor 1130 of FIG. 11A. However, it should be construed that the description is also applicable to the processor 121 of FIGS. 1A and 1B and the processor 1130 of FIG. 11B in a similar manner.

If a write command is received from the host device 110 via the host interface unit 1180, then the processor 1130 determines whether on not a writable area is insufficient in a zone corresponding to the write command based on the management information 1170-1 stored in the RAM 1170 (S1701).

The determination in the step S1701 may be carried out as illustrated in an operational flow chart in FIG. 18. FIG. 18 is an operational flow chart illustrating the process of determining whether or not a writable area is insufficient in the zone in a data write method according to a preferred embodiment of the present invention.

Referring to FIG. 18, the processor 1130 detects a remaining area of the virtual band currently being used using the management information 1170-1, and detects an area-to-be-written from the received write command (S1801). The detection of the remaining area of the virtual band currently being used and the detection of the area-to-be-written may be carried out as described in the remaining area detection unit 1501 and the area-to-be-written detection unit 1502 illustrated in FIG. 15.

If the area-to-be-written is greater than the remaining area, then the processor 1130 checks whether or not the relevant zone has a free virtual band using the management information 1170-1 (S1802, S1803). At this time, the free virtual band may include a remain VB and a reserved VB.

As a result of the check, if the relevant zone does not have a free virtual band, then it is determined that a writable area is insufficient in the zone, and thus the process is advanced to step S1702. On the contrary, if the area-to-be-written is not greater than the remaining area or the relevant zone has a free virtual band even when the area-to-be-written is greater than the remaining area, then it is determined that the writable area is not insufficient in the relevant zone, and thus the process is advanced to step S1703.

If it is determined that a writable area is insufficient in the zone in the step S1701 of FIG. 17, then the processor 1130 refers to the management information 1170-1 to write data into at least one common VB of the disk 12 (S1702). As a result of the determination in the step S1701 of FIG. 1, if the relevant zone does not lack a writable area, then the processor 1130 writes data into a virtual band currently being used in the zone or writes data into a free virtual band selected from the free virtual bands assigned to the zone (S1703). When selecting a free virtual band from the free virtual bands assigned to the zone, the processor 1130 may refer to the management information 1170-1.

FIG. 19 is an operational flow chart illustrating a data write method according to another preferred embodiment of the present invention. FIG. 19 is an example to which an operation is added when a free virtual band is generated due to a merge generation subsequent to writing data in the operation flow char in FIG. 17. Accordingly, steps S1901, S1902 and S1907 in FIG. 19 correspond to the steps S1701 through S1703, and thus the description thereof will be omitted.

If a data write operation according to the received write command is completed, then the processor 1130 performs an update of the management information 1170-1 according to the write operation. Subsequent to the update of the management information 1170-1, the processor 1130 checks whether or not at least one free virtual band is generated from the relevant zone (S1905). When the check is carried out using the management information 1170-1 or a merge operation is carried out subsequent to writing data in the processor 1130, it is determined that a free virtual band is generated.

If a free virtual band is not generated from the relevant zone, then the processor 1130 terminates the process (S1905). In other words, if it is determined that a merge operation is not carried out subsequent to completing data write or a free virtual band is not generated based on the management information 1170-1, then the processor 1130 can terminate the process. However, if at least one free virtual band is generated from the relevant zone, then the processor 1130 updates the management information 1170-1 on the disk 12 to allow the generated free virtual band to be contained in the common VB (S1906).

The step S1906 may be modified to update the management information 1170-1 on the disk 12 so as to determine whether the generated free virtual band is a virtual band that has been assigned to the relevant zone or was a common virtual band, and then allow the generated free virtual band to be contained in the relevant zone when it is a virtual band that has been assigned to the relevant zone, and allowing the generated free virtual band to be contained in the common virtual band when it is not a virtual band that has been assigned to the relevant zone but was a common virtual band. Whether or not the generated free virtual band is a virtual band that has been assigned to the relevant zone may be carried out by comparing the identification information of the virtual band with information on virtual bands contained in each zone that has been configured in advance.

Otherwise, if a free virtual band is generated, then the processor 1130 determines whether the zone from which the free virtual band is generated is a zone that has used at least one common VB, and if it is a zone that has used at least one common VB, then the processor 1130 may update the management information 1170-1 on the disk 12 to allow the generated free virtual band to be contained in the common VB, and if the zone from which the free virtual band is a zone that has not used at least one common VB, then the processor 1130 may update the management information 1170-1 on the disk 12 to allow the generated free virtual band to be contained in the free virtual band of the relevant zone.

FIG. 20 is an operational flow chart illustrating when generating a free virtual band in a data write method according to a preferred embodiment of the present invention, and it may be construed that the process corresponds to the steps of 1905 and S1906 in FIG. 19. However, FIG. 20 may be also applicable to a case where a free virtual band is generated by a merge generated when the storage device 120 is in an idle state.

Referring to FIG. 20, if it is determined that a free virtual band is generated by a merge operation in step S2001, then the processor 1130 checks whether the zone from which a free virtual band is generated uses at least one common VB based on the management information 1170-1 (S2102).

As a result of the check, if the zone from which a free virtual band has been generated is a zone that has used at least one common VB, then the processor 1130 deletes information on the generated free virtual band from the management information of the relevant zone, and updates the management information 1170-1 to allow information on the generated free virtual band to be registered (or contained) in the management information of the common VB (S2003). On the contrary, if it is determined that it is not a zone that has used at least one common VB, then the processor 1130 updates the management information 1170-1 to allow information of the generated free virtual band to be registered (or contained) in the management information of the relevant zone (S2004).

FIG. 21 is a block configuration example illustrating a network system capable of performing a data write method according to a preferred embodiment of the present invention.

Referring to FIG. 21, a network system 2100 may include a program providing terminal 2101, a network 2102, a host PC 2103, and a storage device 2104.

A write operation program used to implement a data write operation according to a preferred embodiment of the present invention as illustrated in FIGS. 17 through 20 is stored in the program providing terminal 2101. The program providing terminal 2101 performs the process of transmitting a data write operation program to the host PC 2103 according to a program transmission request from the host PC 2103 accessed via the network 2102.

The network 2102 may be implemented by a wired or wireless communication network. When the network 2102 is implemented by a communication network such as the Internet, the program providing terminal 2101 may be a website.

The host PC 2103 may include hardware and software capable of accessing the program providing terminal 2101 via the network 2102, and then performing the operation of downloading a data write program according to a preferred embodiment of the present invention.

The host PC 2103 allows a data write method according to a preferred embodiment of the present invention to be carried out in the storage device 2104 based on the method illustrated in FIGS. 17 through 20 by a program downloaded from the program providing terminal 2101.

FIG. 22 is an operational flow chart illustrating a data write method according to a preferred embodiment of the present invention based on the network system 2101 illustrated in FIG. 21.

Referring to FIG. 22, subsequent to accessing the program providing terminal 2101, the host PC 2103 transmits information for requesting a data write program to the program providing terminal 2101 (S2201, S2202).

The program providing terminal 2101 transmits the requested data write program to the host PC 2103, and the host PC 2103 downloads the data write program (S2203). The host PC 2103 processes the downloaded data write program to be carried out in the storage device 2104 (S2204). The data write program is executed in the storage device 2104 to write data into at least one common VB prior to performing a merge when a writable area is insufficient for each zone, thereby preventing the performance of a data write operation from being deteriorated. Subsequent to the data write operation, the storage device 2104 updates the management information of the storage medium 124 or disk 12 (S2205).

Through the foregoing operation, it may be possible to control a data write operation for a storage medium via a wired or wireless network.

In some embodiments, a method for writing data may comprise: writing data onto at least one common virtual band on a storage medium when at least one of a plurality of zones on the storage medium lacks a writable area; and writing the data onto a zone corresponding to a logical address contained in a write command when each of the plurality of zones does not lack a writable area. The embodiment may include, wherein the common virtual band comprises at least one virtual band contained in at least one of the plurality of zones or at least one virtual band contained in at least two of the plurality of zones, respectively. The embodiment may further comprise: determining whether or not a zone corresponding to a logical address contained in the write command lacks a writable area when receiving the write command. The embodiment may further comprise: updating management information on the storage medium to allow the generated free virtual band to be contained in the common virtual band when at least one free virtual band is generated from at least one zone on the storage medium. The embodiment may further comprise: updating the management information of the storage medium to allow the generated free virtual band to be contained in the common virtual band when at least one free virtual band is generated from at least one zone on the storage medium and the zone from which the free virtual band is generated is a zone that uses the common virtual band; and updating the management information of the storage medium to allow the generated free virtual band to be contained in the zone when the zone from which the at least one free virtual band is generated is a zone that does not use the common virtual band.

In some embodiments, a storage device may comprise: a storage medium having a plurality of zones configured to use at least one virtual band contained in at least one of the plurality of zones as at least one common virtual band; and a processor configured to write data onto the at least one common virtual band when at least one of the plurality of zones lacks a writable area. The embodiment may include, wherein the processor writes data onto a zone corresponding to a logical address contained in a write command when each of the plurality of zones does not lack a writable area. The embodiment may include, wherein the processor checks whether or not a zone corresponding to a logical address contained in the write command lacks a writable area when receiving the write command. The embodiment may include, wherein the processor comprises: a first processor configured to extract a logical address from the received write command; a second processor configured to convert the extracted logical address into a virtual address based on the plurality of zones or the at least one common virtual band; and a third processor configured to convert the converted virtual address into a physical address of the storage medium, and access the storage medium according to the converted physical address. The embodiment may include, wherein the processor updates management information on the storage medium to allow the generated free virtual band to be contained in the common virtual band when at least one free virtual band is generated from at least one zone of the storage medium.

A program for performing a data write method according to an embodiment of the present invention may be implemented as codes readable by a computer on a storage medium. The computer-readable storage medium includes all kinds of storage devices in which data readable by a computer system can be stored. Examples of the computer-readable storage medium may include ROM, RAM, CD-ROM, magnetic tape, floppy disk, and optical data storage device, and the like. Also, the computer-readable storage medium may be distributed over computer systems connected via a network, and stored and executed as computer-readable codes in a distributed method.

Up to now, the present invention has been described around preferred embodiments thereof. It will be apparent to those skilled in this art that various modifications may be made thereto without departing from the gist of the present invention. Accordingly, it should be noted that the embodiments disclosed in the present invention are merely illustrative but not restrictive to the concept of the present invention. The scope of the present invention is defined by the appended claims rather than the foregoing description, and all differences within the equivalent scope of the invention should be construed to be included in the present invention.

### DESCRIPTION OF REFERENCE NUMERALS IN THE DRAWINGS

[FIG. 1]
120a Storage device
110 Host device
127 Host interface unit
121 Processor
125 Storage medium interface unit
124 Storage medium
123 ROM
122 RAM
128 Non-volatile memory

[FIG. 2-4]
[symbol] Zone
[symbol] Logical band
[symbol] Virtual band
[symbol] 1 [symbol] VB VB of zone 1
[symbol] 1 [symbol] VB Reserved VB of zone 1
[symbol] 2 [symbol] VB VB of zone 2
[symbol] 2 [symbol] VB Reserved VB of zone 2

[FIG. 11]
1110 Pre-amp
1120 R/W channel
1180 Host interface unit
1140 VCM driving unit
1150 SPM driving unit
1130 Processor
1170-1 Management information
1190 Non-volatile memory

[FIG. 12]
[symbol] Command
[symbol] Management information
[symbol] or [symbol] Storage medium or disk
[symbol] 1 [symbol] First processor
[symbol] 2 [symbol] Second processor
[symbol] 3 [symbol] Third processor

[FIG. 13]
[symbol] Garbage queue
[symbol] Allocation queue
[symbol] Free queue
[symbol] VB Common VB

[FIG. 14]
[symbol] Write command
[symbol] [symbol] Management information of storage medium
1401 First check unit
1402 Band selection unit
1403 Write operation controller
[symbol] [symbol] or [symbol] [symbol] [symbol] Storage medium interface unit or its corresponding element

[FIG. 15]
[symbol] [symbol] Write command
[symbol] [symbol] Management information of storage medium
1501 Remaining area detection unit
1502 Area-to-be-written detection unit
1503 Comparison unit
1504 Second check unit
1505 Determination unit
[symbol] [symbol] Band selection unit

[FIG. 16]
[symbol] Logical band
[symbol] Virtual band

[FIG. 17]

Start
S1701 Is writable area insufficient in at least one of plurality of zone?

Yes/No
S1702 Write data into common VB
S1703 Write data into zone

End

[FIG. 18]
S1801 Detect remaining area of virtual band currently being used and area-to-be-written
S1802 Area-to-be-written>Remaining area
S1803 Is there free virtual band in the zone?

Yes/No

[FIG. 19]

Start
S1901 Is writable area insufficient in the zone?

Yes/No
S1902 Write data into common VB
S1903 Is data write completed?

Yes/No
S1904 Update management information based on the write
S1905 Free virtual band is generated?
S1906 Update management information based on the generated free

virtual band
S1907 Write data into zone
S1908 Update management information based on the write

End

[FIG. 20]

Start
S2001 Is free virtual band generated?

Yes/No
S2002 Is it zone using common VB?
S2003 Update management information on storage medium
S2004 Update management information on zone of storage medium

End

[FIG. 21]
2101 Program providing terminal
2102 Network
2103 Host PC
2104 Storage device

[FIG. 22]

Start
S2201 Access program providing terminal
S2202 Request data write program
S2203 Download data write program
S2204 Execute data write program
S2205 Update management information of storage medium

End

1.-10. (canceled)

11. An apparatus comprising:
a controller configured to:
receive a command including write data and address data identifying a target zone of a data storage medium having a plurality of zones;
determine whether the target zone contains sufficient available data sectors to store the write data; and
record the write data to a common area of a different zone when the target zone does not contain sufficient available data sectors, the common area available to store data when a target zone lacks sufficient available data sectors.

12. The apparatus of claim 11, further comprising the controller configured to record the write data on data tracks of the data storage medium in a shingled manner where a first track is partially overwritten by a second track.

13. The apparatus of claim 11, further comprising:
one or more zones from the plurality of zones include a plurality of virtual bands, a virtual band including one or more data tracks; and
the common area is a virtual band designated as a common virtual band.

14. The apparatus of claim 13, further comprising the controller configured to:
determine a selected virtual band of the target zone containing invalid data;
transfer valid data from the selected virtual band to available data sectors of another virtual band; and
designate the selected virtual band as an available virtual band for writing data.

15. The apparatus of claim 14, further comprising the controller configured to designate the selected virtual band as an available common virtual band for writing data from zones not containing sufficient available data sectors to store write data.

16. The apparatus of claim 13, further comprising the controller configured to:
write data to a first virtual band of the target zone until the first virtual band lacks sufficient data sectors, and then write data to a second virtual band of the target zone; and
determine whether the target zone contains sufficient available data sectors to store the write data via:
determine whether the first virtual band contains sufficient available data sectors to store the write data; and
when the first virtual band does not contain sufficient available data sectors, determine whether the second virtual band is available to store the write data.

17. The apparatus of claim 11, further comprising the controller configured to update a mapping table to indicate the write data was written to the common area of the different zone.

18. The apparatus of claim 11, further comprising the data storage medium.

19. A method comprising:
receiving a command including write data and address data identifying a target zone of a data storage medium having a plurality of zones;
determining whether the target zone contains sufficient available data sectors to store the write data; and
recording the write data to a common area of a different zone when the target zone does not contain sufficient available data sectors, the common area available to store data when a target zone lacks sufficient available data sectors.

20. The method of claim 19, further comprising recording the write data on data tracks of the data storage medium in a shingled manner where a first track is partially overwritten by a second track.

21. The method of claim 19, further comprising one or more zones from the plurality of zones include a plurality of virtual bands, a virtual band including one or more data tracks, and the common area is a virtual band designated as a common virtual band.

22. The method of claim 21, further comprising:
determining a selected virtual band of the target zone containing invalid data;
transferring valid data from the selected virtual band to available data sectors of another virtual band; and
designating the selected virtual band as an available virtual band for writing data.

23. The method of claim 22, further comprising designating the selected virtual band as an available common virtual band for writing data from zones not containing sufficient available data sectors to store write data.

24. The method of claim 21, further comprising:
writing data to a first virtual band of the target zone until the first virtual band lacks sufficient data sectors, and then writing data to a second virtual band of the target zone; and
determining whether the target zone contains sufficient available data sectors to store the write data via:
determining whether the first virtual band contains sufficient available data sectors to store the write data; and
when the first virtual band does not contain sufficient available data sectors, determining whether the second virtual band is available to store the write data.

25. A computer readable storage medium storing instructions that cause a processor to perform a method comprising:
receiving a command including write data and address data identifying a target zone of a data storage medium having a plurality of zones;
determining whether the target zone contains sufficient available data sectors to store the write data; and
recording the write data to a common area of a different zone when the target zone does not contain sufficient available data sectors, the common area available to store data when a target zone lacks sufficient available data sectors.

26. The computer readable storage medium of claim 25, the method further comprising recording the write data on data tracks of the data storage medium in a shingled manner where a first track is partially overwritten by a second track.

27. The computer readable storage medium of claim 25, further comprising one or more zones from the plurality of zones include a plurality of virtual bands, a virtual band including one or more data tracks, and the common area is a virtual band designated as a common virtual band.

28. The computer readable storage medium of claim 27, the method further comprising:
determining a selected virtual band of the target zone containing invalid data;
transferring valid data from the selected virtual band to available data sectors of another virtual band; and
designating the selected virtual band as an available virtual band for writing data.

29. The computer readable storage medium of claim 28, the method further comprising designating the selected virtual band as an available common virtual band for writing data from zones not containing sufficient available data sectors to store write data.

30. The computer readable storage medium of claim 27, the method further comprising:
writing data to a first virtual band of the target zone until the first virtual band lacks sufficient data sectors, and then writing data to a second virtual band of the target zone; and
determining whether the target zone contains sufficient available data sectors to store the write data via:
determining whether the first virtual band contains sufficient available data sectors to store the write data; and
when the first virtual band does not contain sufficient available data sectors, determining whether the second virtual band is available to store the write data.
